(19) United States
(12) Patent Application Publication
(10) Pub. No.: US 2013/0038228 A1
(43) Pub. Date: Feb. 14, 2013

(54) DRIVER CICRUIT APPARATUS FOR AN LED STRING, LIGHT SOURCE APPARATUS AND INTEGRATED CIRCUIT

(71) Applicant: Sheng-Chun Hu, Jhubei City (TW)

(72) Inventor: Sheng-Chun Hu, Jhubei City (TW)

(21) Appl. No.: 13/579,060

(22) PCT Filed: Feb. 15, 2010
(86) PCT No.: PCT/EP10/51869

§ 371 Date: Oct. 18, 2012

(51) Int. Cl. H05B 37/02

(52) U.S. Cl. 315/193

(57) ABSTRACT

A driver circuit apparatus for light emitting diodes comprises a current mirror (212) that includes a first branch for coupling to a first string of light emitting diodes (202), and a second branch for coupling to a second string of light emitting diodes (204). The apparatus also comprises a voltage controlled current source (214) coupled to the current mirror (212).

### FIELD OF THE INVENTION

The present invention relates to a driver circuit apparatus of the type that, for example, comprises a current mirror circuit for driving a string of Light Emitting Diodes (LEDs). The present invention also relates to a light source apparatus of the type that, for example, comprises a current mirror circuit for driving a string of LEDs. The present invention further relates to an integrated circuit of the type that, for example, comprises a current mirror circuit for driving a string of LEDs.

### BACKGROUND TO THE INVENTION

Portable computing devices, for example Portable Navigation Devices (PNDs), which include GPS (Global Positioning System) signal reception and processing functionality are well known and are widely employed as in-car or other vehicle navigation systems.

In general terms, a modern PND comprises a processor, memory, and map data stored within said memory. The processor and memory cooperate to provide an execution environment in which a software operating system can be established, and additionally it is commonplace for one or more additional software programs to be provided to enable the functionality of the PND to be controlled, and to provide various other functions.

Typically, these devices further comprise one or more input interfaces that allow a user to interact with and control the device, and one or more output interfaces by means of which information may be relayed to the user. Illustrative examples of output interfaces include: a visual display and a speaker for audible output. Illustrative examples of input interfaces include: one or more physical buttons to control on/off operation or other features of the device (which buttons need not necessarily be on the device itself but could be on a steering wheel if the device is built into a vehicle), and a microphone for detecting user speech. In one particular arrangement, the output interface display may be configured as a touch sensitive display (by means of a touch sensitive overlay or otherwise) additionally to provide an input interface by means of which a user can operate the device through the display.

Devices of this type will also often include one or more physical connector interfaces by means of which power and optionally data signals can be transmitted to and received from the device, and optionally one or more wireless transmitters/receivers to allow communication over cellular telecommunications and other signal and data networks, for example Bluetooth, Wi-Fi, Wi-Max, GSM, UMTS and the like.

PNDs of this type also include a GPS antenna by means of which satellite-broadcast signals, including location data, can be received and subsequently processed to determine a current location of the device.

The PND may also include electronic gyroscopes and accelerometers which produce signals that can be processed to determine the current angular and linear acceleration, and in turn, and in conjunction with location information derived from the GPS signal, velocity and relative displacement of the device and thus the vehicle in which it is mounted. Typically, such features are most commonly provided in in-vehicle navigation systems, but may also be provided in PNDs if it is expedient to do so.

The utility of such PNDs is manifested primarily in their ability to determine a route between a first location (typically a start or current location) and a second location (typically a destination). These locations can be input by a user of the device, by any of a wide variety of different methods, for example by postcode, street name and house number, previously stored “well known” destinations (such as famous locations, municipal locations (such as sports grounds or swimming baths) or other points of interest), and favourite or recently visited destinations.

Typically, the PND is enabled by software for computing a “best” or “optimum” route between the start and destination address locations from the map data. A “best” or “optimum” route is determined on the basis of predetermined criteria and need not necessarily be the fastest or shortest route. The selection of the route along which to guide the driver can be very sophisticated, and the selected route may take into account existing, predicted and dynamically and/or wirelessly received traffic and road information, historical information about road speeds, and the driver's own preferences for the factors determining road choice (for example the driver may specify that the route should not include motorways or toll roads).

PNDs of this type may typically be mounted on the dashboard or windscreen of a vehicle, but may also be formed as part of an on-board computer of the vehicle radio or indeed as part of the control system of the vehicle itself. The navigation device may also be part of a hand-held system, such as a PDA (Portable Digital Assistant), a media player, a mobile phone or the like, and in these cases, the normal functionality of the hand-held system is extended by means of the installation of a hardware module and/or software on the device to perform both route calculation and navigation along a calculated route.

In the context of a PND, once a route has been calculated, the user interacts with the navigation device to select the desired calculated route, optionally from a list of proposed routes. Optionally, the user may intervene in, or guide the route selection process, for example by specifying that certain routes, roads, locations or criteria are to be avoided or are mandatory for a particular journey. The route calculation aspect of the PND forms one primary function, and navigation along such a route is another primary function.

During navigation along a calculated route, it is usual for such PNDs to provide visual and/or audible instructions to guide the user along a chosen route to the end of that route, i.e. the desired destination. It is also usual for PNDs to display map information on-screen during the navigation, such information regularly being updated on-screen so that the map information displayed is representative of the current location of the device, and thus of the user or user's vehicle if the device is being used for in-vehicle navigation.

An icon displayed on-screen typically denotes the current device location, and is centred with the map information of current and surrounding roads in the vicinity of the current device location and other map features also being displayed. Additionally, navigation information can be displayed, optionally in a status bar above, below or to one side of the displayed map information, an example of the navigation information includes a distance to the next deviation from the current road required to be taken by the user, the nature of that deviation possibly being represented by a further icon suggestive of the particular type of deviation, for example a left or right turn. The navigation function also determines the content, duration and timing of audible instructions by means of which the user can be guided along the route. As can be appreciated, a simple instruction such as “turn left in 100 m” requires significant processing and analysis. As previously mentioned, user interaction with the device may be by a touch screen, or additionally or alternately by steering column mounted remote control, by voice activation or by any other suitable method.

In relation to the on-screen display, it is known for some navigation devices to comprise a Liquid Crystal Display (LCD) display. In the field of LCD displays, it is also known to provide a so-called “backlight” to serve as a source of visible electromagnetic energy that can be selectively permitted to pass through pixels of an LCD panel so that a visible image formed by the LCD panel can be seen by a viewer, for example a user of the navigation device. In this respect, a number of different types of electromagnetic emission devices have been proposed as backlights for LCD displays, for example a fluorescent backlight. More recently, LEDs have been used as backlights for LCD displays. In this respect, the skilled person will appreciate that the term “backlight” simply refers to the fact that light is emitted behind the LCD panel and does not necessarily identify the exact location of the light emitting device(s) that generate the light. For example, the LEDs can be edge-located, light emitted being suitably delivered to the backside of the LCD panel by one or more light guides or the like.

Typically, the LEDs are connected as one or more “strings” of LEDs in order to form the LED light source. In this respect, the LEDs are series coupled, or daisy-chained together, with a view to providing uniform illumination, a same current being expected to flow through each LED. In order to drive the LED light source, it is known to provide an LED driver circuit for each string of LEDs employed in the LED light source. Consequently, where N strings of LEDs are employed, it is necessary to provide N LED driver circuits. However, this solution results in a large component or die space being required and, of course, has a cost penalty associated with the additional components that need to be provided.

As an alternative, a simple current mirror circuit architecture has been proposed, whereby either NPN-type or PNP-type bipolar transistors are employed in a driver circuit to drive two or more strings of LEDs. The advantage of this driver circuit design is the use of fewer components and hence reduced component space being required for the driver circuit, as well as the low-cost of bipolar transistors for such circuit designs resulting in a reduced manufacturing cost for the driver circuit.

Typically, current mirror-type driver circuits comprise N strings of LEDs coupled in parallel between a supply rail and a ground rail of the driver circuit. One type of driver circuit comprises a current mirror coupled between the N strings of LEDs and the ground rail. If one considers a simple two-string example, a first terminal of a first string of LEDs and a first terminal of a second string of LEDs are coupled to the supply rail. A second terminal of the first string of LEDs is coupled to a collector terminal of a first NPN transistor and a base terminal of the first NPN transistor. An emitter terminal of the first NPN transistor is coupled to a first current source resistor, the first resistor being coupled to the ground rail via a feedback resistor. Similarly, a second terminal of the second string of LEDs is coupled to a collector terminal of a second NPN transistor, a base terminal of the second NPN transistor being coupled to the base terminal of the first NPN transistor and hence the collector terminal of the first NPN transistor. An emitter terminal of the second NPN transistor is coupled to the feedback resistor via a second current source resistor. The first and second NPN transistors and the first and second resistors constitute the current mirror.

An alternative design comprises the current mirror circuit being coupled between the supply rail and the N strings of LEDs, the first and second transistors being PNP transistors and the first and second resistors being coupled between the supply rail and the first and second PNP transistors, respectively.

Unfortunately, these current mirror driver circuit designs provide inconsistent illumination between strings of LEDs as a result of inconsistent currents flowing through each string of LEDs. By way of further explanation in the context of the first current mirror-type driver circuit comprising the first and second NPN transistors, a first current, IC₁, flows through the first string of LEDs and a second current, IC₂, flows through the second string of LEDs. The value of the first current, IC₁, approaches the value of the second current, IC₂, as a first voltage, V₁, at the collector of the first NPN transistor equals or approaches a second voltage, V₂, at the collector of the second NPN transistor. Under this condition, and ignoring the base currents and the so-called “early effect”, the first and second NPN transistors are operating in their respective active regions. However, the forward voltages of the LEDs in each of the first and second strings of LEDs vary, for example due to temperature effects and ageing effects, such as between about 3.0V and 3.4V at a forward current of 20 mA. Consequently, maintenance of balance of the first and second currents, IC₁, IC₂, cannot always be achieved by the driver circuit; as soon as the first voltage, V₁, begins to exceed the second voltage, V₂, by about 0.5V, the second NPN transistor enters a saturated region of operation and the balanced condition of the first and second currents, IC₁, IC₂, is lost. Indeed, the degree of imbalance between the first and second currents, IC₁, IC₂, relates to the magnitude of the difference between the first and second voltages, V₁, V₂, and may be of the order of tens of milliamps. A considerable variation in illumination intensity between the first and second strings of LEDs can therefore result and is undesirable.

### SUMMARY OF THE INVENTION

According to a first aspect of the present invention, there is provided a driver circuit apparatus for light emitting diodes, the apparatus comprising: a current mirror including: a first branch for coupling to a first string of light emitting diodes; and a second branch for coupling to a second string of light emitting diodes; and a voltage controlled current source coupled to the current mirror.

The voltage controller current source may include: a first branch coupled to the first branch of the current mirror; and a second branch coupled to the second branch of the current mirror.

The voltage controlled current source may be arranged to generate a feedback signal for controlling an operating voltage of the current mirror.

The feedback signal may be a negative feedback signal.

The current mirror may comprise a first switching device and a second switching device; the first switching device may have a first control terminal coupled to a second control terminal of the second switching device.

The first switching device may comprise a first conduction terminal for coupling to the first string of light emitting diodes; and the second switching device may comprise a first conduction terminal for coupling to the second string of light emitting diodes.

The first switching device may comprise a second conduction terminal coupled to a first current source; and the second switching device may comprise a second conduction terminal coupled to a second current source.

The first switching device may be a first transistor device and the second switching device may be a second transistor device.

The first and second transistor devices may be bipolar transistor devices. The first and second transistor devices may be NPN bipolar transistor devices.

The voltage controlled current source may comprise a third switching device and a fourth switching device; the third switching device may have a first control terminal for coupling to the first string of light emitting diodes, and the fourth switching device may have a second control terminal for coupling to the second string of light emitting diodes.

The first control terminal of the third switching device may be coupled to the first conduction terminal of the first switching device; and the second control terminal of the fourth switching device may be coupled to the first conduction terminal of the second switching device.

The first control terminal of the third switching device may be coupled to a first voltage clamp.

The second control terminal of the fourth switching device may be coupled to a second voltage clamp.

A first conduction terminal of the third switching device may be coupled to a third current source and a first conduction terminal of the fourth switching device may be coupled a fourth current source.

A second conduction terminal of the third switching device may be coupled to the first control terminal of the first switching device, and a second conduction terminal of the fourth switching device may be coupled to the second control terminal of the second switching device.

The apparatus may further comprise a first resistance coupled between the first control terminal and the second conduction terminal of the third switching device, and a second resistance may be coupled between the second control terminal and the second conduction terminal of the fourth switching device.

The third switching device may be a third transistor device and the fourth switching device is a fourth transistor device.

The third and fourth transistor devices may be bipolar transistor devices. The third and fourth transistor devices may be PNP bipolar transistor devices.

The first and second branches of the current mirror may be substantially symmetric and the first and second branches of the voltage controlled current source may be substantially symmetric.

According to a second aspect of the present invention, there is provided a light source apparatus comprising: the driver circuit apparatus as set forth above in relation to the first aspect of the invention; a first string of light emitting diodes; and a second string of light emitting diodes; wherein the first string of light emitting diodes is coupled to the first branch of the current mirror, and the second string of light emitting diodes is coupled to the second branch of the current mirror.

According to a third aspect of the present invention, there is provided a navigation device comprising the driver circuit apparatus as set forth above in relation to the first aspect of the invention.

According to a fourth aspect of the present invention, there is provided an integrated circuit for driving light emitting diodes, the circuit comprising: a current mirror including: a first branch for coupling to a first string of light emitting diodes; and a second branch for coupling to a second string of light emitting diodes; and a voltage controlled current source coupled to the current mirror.

It is thus possible to provide a driver circuit apparatus, a light source apparatus and method that provide substantially balanced currents flowing through each string of LEDs coupled to the driver circuit under a varied range of voltage drops across each string of LEDs and varying transistor parameters. The apparatus is capable of automatically selecting a string of LEDs having a maximum voltage drop thereacross and use the voltage drop selected as a basis to generate an optimal output voltage in order to achieve a lowest power consumption associated with the apparatus whilst achieving uniform current flow through each of the strings of LEDs coupled to the apparatus. Furthermore, the apparatus and method protect against open-circuits in relation to one or more of the strings of LEDs, which can lead to over-current conditions occurring in other strings of LEDs not suffering from an open circuit. Also, the provision of the apparatus does not represent a significant manufacturing cost increase as compared with existing current mirror-type driver circuits employed. Furthermore, the apparatus is scalable in relation to the number of strings of LEDs that can be driven with minimal difference in the current flowing through each of the strings of LEDs.

Further advantages of these embodiments are set out hereafter, and further details and features of each of these embodiments are defined in the accompanying dependent claims and elsewhere in the following detailed description.

### BRIEF DESCRIPTION OF THE DRAWINGS

At least one embodiment of the invention will now be described, by way of example only, with reference to the accompanying drawings, in which:

FIG. 1 is a schematic illustration of components of a navigation device;

FIG. 2 is a schematic diagram of a simple backlight circuit apparatus comprising a driver circuit apparatus for driving a pair of strings of LEDs and constituting an embodiment of the present invention; and

FIG. 3 is a schematic diagram of the backlight circuit apparatus of FIG. 2 in relation to driving a greater number of strings of LEDs than are driven in relation to FIG. 2.

### DETAILED DESCRIPTION OF PREFERRED EMBODIMENTS

Throughout the following description identical reference numerals will be used to identify like parts.

Embodiments of the present invention will now be described with particular reference to a PND. It should be remembered, however, that the teachings of the present invention are not limited to PNDs but are instead universally applicable to any type of processing device, for example but not limited to those that are configured to execute navigation software in a portable or mobile manner so as to provide route planning and navigation functionality. It follows therefore that in the context of the present application, a navigation device is intended to include (without limitation) any type of route planning and navigation device, irrespective of whether that device is embodied as a PND, a vehicle such as an automobile, or indeed a portable computing resource, for example a portable personal computer (PC), a mobile telephone or a Personal Digital Assistant (PDA) executing route planning and navigation software.

It will also be apparent from the following that the teachings of the present invention even have utility in circumstances where a user is not seeking instructions as to how to navigate from one point to another, but merely wishes to be provided with information concerning, for example, traffic.

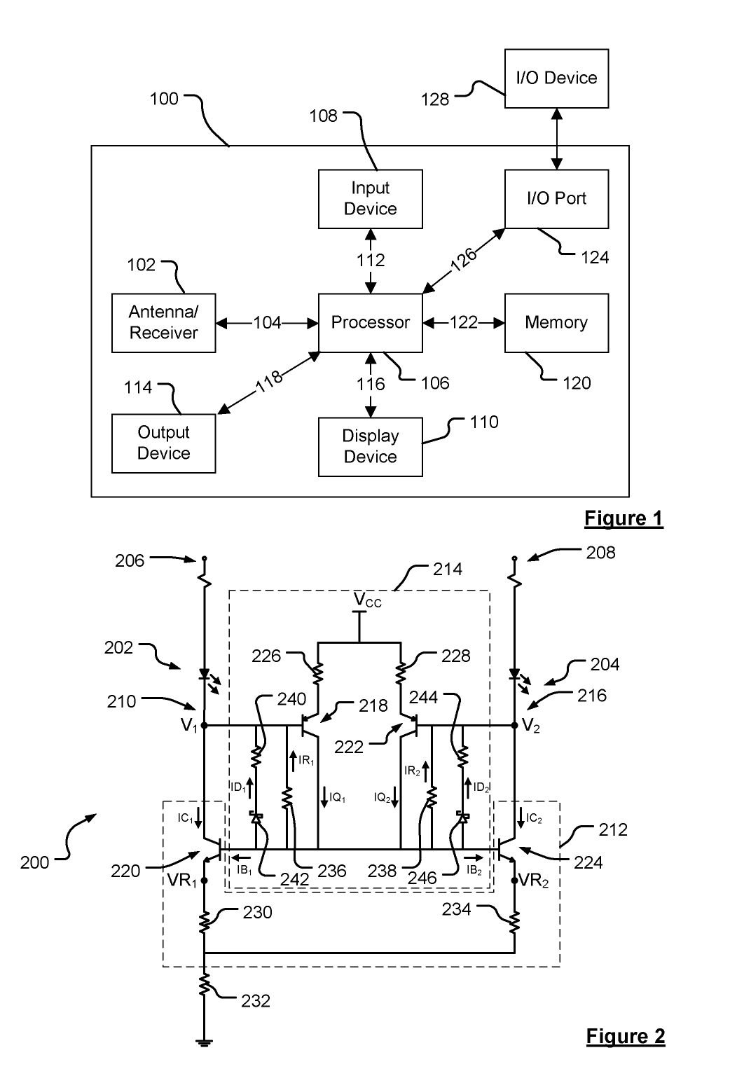

Referring to FIG. 1, a navigation device 100 is located within a housing (not shown). The navigation device 100 comprises or is coupled to a GPS receiver device 102 via a connection 104, wherein the GPS receiver device 102 can be, for example, a GPS antenna/receiver. It should be understood that the antenna and receiver designated by reference numeral 102 are combined schematically for illustration, but that the antenna and receiver may be separately located components, and that the antenna may be a GPS patch antenna or helical antenna for example.

The navigation device 100 includes a processing resource comprising, for example, a processor 106, the processor 106 being coupled to an input device 108 and a display device, for example a display screen 110. Although reference is made here to the input device 108 in the singular, the skilled person should appreciate that the input device 108 represents any number of input devices, including a keyboard device, voice input device, touch panel and/or any other known input device utilised to input information. Likewise, the display screen 110 can include any type of display screen for example a Liquid Crystal Display (LCD).

In one arrangement, one aspect of the input device 108, the touch panel, and the display screen 110 are integrated so as to provide an integrated input and display device, including a touchpad or touchscreen input to enable both input of information (via direct input, menu selection, etc.) and display of information through the touch panel screen so that a user need only touch a portion of the display screen 110 to select one of a plurality of display choices or to activate one of a plurality of virtual or “soft” buttons. In this respect, the processor 106 supports a Graphical User Interface (GUI) that operates in conjunction with the touchscreen.

In the navigation device 100, the processor 106 is operatively connected to and capable of receiving input information from input device 108 via a connection 112, and operatively connected to at least one of the display screen 110 and an output device 114, for example an audible output device (e.g. a loudspeaker), via respective output connections 116, 118. As the output device 114 can produce audible information for a user of the navigation device 100, it should equally be understood that the input device 108 can include a microphone and software for receiving input voice commands. Further, the navigation device 100 can also include any additional input device 108 and/or any additional output device, for example audio input/output devices.

The processor 106 is operatively connected to a memory resource 120 via connection 122 and is further arranged to receive/send information from/to input/output (I/O) port 124 via connection 126, wherein the I/O port 124 is connectible to an I/O device 128 external to the navigation device 100. The memory resource 120 comprises, for example, a volatile memory, such as a Random Access Memory (RAM) and a non-volatile memory, for example a digital memory, such as a flash memory.

The external I/O device 128 may include, but is not limited to, an external listening device, such as an earpiece for example. The connection to I/O device 128 can further be a wired or wireless connection to any other external device, for example a car stereo unit for hands-free operation and/or for voice activated operation, for connection to an earpiece or headphones, and/or for connection to a mobile telephone, the mobile telephone connection can be used to establish a data connection between the navigation device 100 and the Internet or any other network for example, and/or to establish a connection to a server via the Internet or some other network for example.

In this regard, the navigation device 100 is capable of establishing a data session, if required, with network hardware of a “mobile” or telecommunications network via a mobile device (not shown), for example the mobile telephone described above, a PDA and/or any device with mobile telephone technology, in order to establish a digital connection, for example a digital connection via known Bluetooth technology. Thereafter, through its network service provider, the mobile device can establish a network connection (through the Internet for example) with a server (not shown). As such, a “mobile” network connection can be established between the navigation device 100 (which can be, and oftentimes is, mobile as it travels alone and/or in a vehicle) and the server to provide a “real-time” or at least very “up to date” gateway for information.

It will, of course, be understood by one of ordinary skill in the art that the electronic units schematically shown in FIG. 1 are powered by one or more power sources (not shown) in a conventional manner. As will also be understood by one of ordinary skill in the art, that different configurations of the units shown in FIG. 1 are contemplated. For example, the components shown in FIG. 1 may be in communication with one another via wired and/or wireless connections and the like. Thus, the navigation device 100 described herein can be a portable or handheld navigation device 100.

It should also be noted that the block diagram of the navigation device 100 described above is not inclusive of all components of the navigation device 100, but is only representative of many example components.

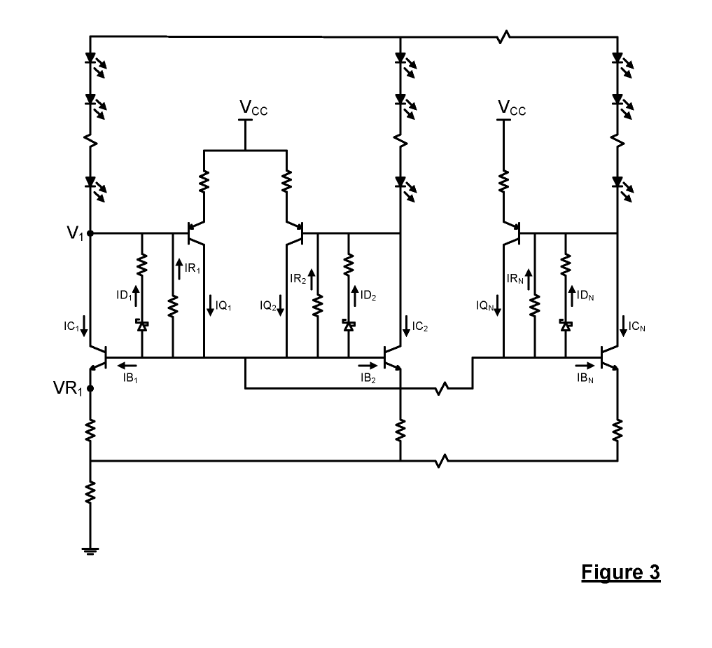

Turning to FIG. 2, and as mentioned above, the navigation apparatus 100 comprises the display screen 110. The display screen 110 comprises, in this example, a Liquid Crystal Display (LCD) display having a light source apparatus (not shown) 200, for example a backlight, disposed behind an LCD panel. The light source apparatus comprises, in this example, a first string of Light Emitting Diodes (LEDs) 202 and a second string of LEDs 204. A first end 206 of the first string of LEDs 202 and a first end 208 of the second string of LEDs 204 are coupled to a supply rail directly. Although not shown, any suitable control circuit can be provided to enable selective illumination of the first string of LEDs 202 and/or the second string of LEDs 204.

A second end 210 of the first string of LEDs 202 is coupled to respective first sides or branches of a current mirror 212 and a voltage controlled current source 214. Similarly, a second end 216 of the second string of LEDs 204 is coupled to respective second sides or branches of the current mirror 212 and the voltage controlled current source 214.

The second end 210 of the first string of LEDs 202 is therefore coupled to a control terminal of a first switching device of the voltage controlled current source 214, for example a base terminal of a first transistor 218 of the voltage controlled current source 214, such as a first PNP bipolar transistor. The second end 210 of the first string of LEDs 202 is also coupled to a first conduction terminal of a first switching device of the current mirror 212, for example a collector terminal of a first transistor 220 of the current mirror 212, such as a first NPN bipolar transistor. Similarly, the second end 216 of the second string of LEDs 204 is coupled to a control terminal of a second switching device of the voltage controlled current source 214, for example a base terminal of a second transistor 222 of the voltage controlled current source 214, such as a second PNP bipolar transistor. The second end 216 of the second string of LEDs 204 is also coupled to a first conduction terminal of a second switching device of the current mirror 212, for example a collector terminal of a second transistor 224 of the current mirror 212, such as a second NPN bipolar transistor. Hence, it can been that the first branch of the current mirror 212 is coupled to the first branch of the voltage controlled current source 214, and the second branch of the current mirror 212 is coupled to the second branch of the voltage controlled current source 214.

A first conduction terminal of the first PNP transistor 218 is coupled to the supply rail, V_{CC}, via a first emitter resistor 226. Similarly, a first conduction terminal of the second PNP transistor 222, for example an emitter terminal, is also coupled to the supply rail, V_{CC}, via a second emitter resistor 228. Second conduction terminals, for example collector terminals, of the first and second PNP transistors 218, 222 are coupled to first and second control terminals, for example base terminals, of the first and second NPN transistors 220, 224.

A second conduction terminal, for example an emitter terminal, of the first NPN transistor 220 is coupled to a first source resistor 230 that serves as a first current source for the first branch of the current mirror 212, the first source resistor 230 being coupled to ground potential via a feedback resistor 232. Similarly, a second conduction terminal, for example an emitter terminal, of the second NPN transistor 224 is coupled to a second source resistor 234 that serves as a second current source for the second branch of the current mirror 212, the second source resistor 234 being coupled to the first source resistor 230, and to the ground potential via the feedback resistor 232. Likewise, the first emitter resistor 226 constitutes a third current source and the second emitter resistor 228 constitutes a fourth current source.

The base terminal of the first PNP transistor 218 is coupled to the base terminal of the first NPN transistor 220 and the base terminal of the second NPN transistor 224 via a first base resistor 236. Similarly, the base terminal of the second PNP transistor 222 is coupled to the base terminal of the second NPN transistor 224 and the base terminal of the first NPN transistor 220 via a second base resistor 238. Additionally, the base terminal of the first PNP transistor 218 is coupled to a first clamp resistor 240, the first clamp resistor 240 being coupled to the base terminal of the first NPN transistor 220 and the base terminal of the second NPN transistor 224 via a first Schottky diode 242. Likewise, the base terminal of the second PNP transistor 222 is coupled to a second clamp resistor 244, the second clamp resistor 244 being coupled to the base terminal of the second NPN transistor 224 and the base terminal of the first NPN transistor 220 via a second Schottky diode 246. The first and second Schottky diodes 242, 246 serve to provide respective voltage clamps.

The current mirror 212 coupled to the voltage controlled current source 214, together, constitute a driver circuit for the first and second strings of LEDs 202, 204. In this example, the light source apparatus includes the driver circuit.

In another embodiment of the invention, the driver circuit can be applied in respect of a greater number of strings of LEDs. In this respect, the second side or branch of the current mirror 212 and the second side or branch of the voltage controlled current source 214 are replicated for each string of LEDs. Indeed, the circuit diagram of FIG. 3 relates to a light source apparatus that comprises N strings of LEDs.

Referring back to FIG. 2, the driver circuit is designed to minimise power consumption as defined by (IC₁×V₁)+(IC₂×V₂), where IC₁ is a first current flowing through the first branch of the current mirror 212, IC₂ is a second current flowing through the second branch of the current mirror 212, V₁ is a first collector voltage of the first NPN transistor 220, and V₂ is a second collector voltage of the second NPN transistor 224. In order to minimise power consumption, the driver circuit is configured so that the first collector voltage, V₁, or the second collector voltage, V₂, is as low as possible, for example about 0.3V above a first emitter voltage (VR₁+0.3V) or about 0.3V above a second emitter voltage (VR₂+0.3V), i.e. slightly higher than the first or second collector-emitter saturation voltages. Also, the first collector-emitter voltage (V₁−VR₁) of the first NPN transistor 220, where VR₁ is the first emitter voltage of the first NPN transistor 220, or the second collector-emitter voltage (V₂−VR₂) of the second NPN transistor 224, where VR₂ is the second emitter voltage of the second NPN transistor 224, is set sufficiently high, for example above the collector-emitter saturation voltage, to ensure that the first or second NPN transistors 220, 224 are operating in their respective saturated regions.

As can be seen from FIG. 2, the driver circuit is substantially symmetric. In this respect, the resistance value of the first emitter resistor 226 is the same as the resistance value of the second emitter resistor 228, the resistance value of the first base resistor 236 is the same as the resistance value of the second base resistor 238, the resistance value of the first source resistor 230 is the same as the resistance value of the second source resistor 234, and the first and second PNP transistors 218, 222, the first and second NPN transistors 220, 224 and the first and second Schottky diodes 242, 246 are selected to possess like operational parameters.

However, it should be appreciated that whilst the first and second clamp resistors 240, 244 have like resistance values, the provision of the first and second clamp resistors 240, 244 is not mandatory to maintain balanced current flows through the first and second strings of LEDs 202, 204, and are employed to reduce the first and second collector voltages, V₁, V₂, in order to reduce power consumption of the light source apparatus.

In operation, in a first state, the respective voltage drops across the first and second strings of LEDs 202, 204 are substantially equal, resulting in the first and second collector voltages, V₁, V₂, being substantially the same. When operating in their respective active regions, the base-emitter voltages of the first and second NPN transistors 220, 224 are about 0.7V and the collector-emitter voltages, V_{CE}, of the first and second NPN transistors 220, 224 are 0.3V. Consequently, the first and second collector voltages, V₁, V₂ are about 0.4V less than the base voltages, V_{B}, of the first and second NPN transistors 220, 224. The values of the first and second emitter resistors 226, 228, the first and second base resistors 236, 238, the first and second clamp resistors 240, 244, and the Schottky diodes 242, 246 have been selected such that the following current conditions are met:

IQ₁=IR₁+ID₁+IB₁ (1)

IQ₂=IR₂+ID₂+IB₂ (2)

In equations (1) and (2), IQ₁ is a first collector current flowing through the first PNP transistor 218, IR₁ is a first base resistor current flowing through the first base resistor 236, ID₁ is a first diode current flowing through the first Schottky diode 242, and IB, is a first base current flowing into the base terminal of the first NPN transistor 220. Similarly, IQ₂ is a second collector current flowing through the second PNP transistor 224, IR₂ is a second base resistor current flowing through the second base resistor 238, ID₂ is a second diode current flowing through the second Schottky diode 246, and IB₂ is a second base current flowing into the base terminal of the second NPN transistor 224.

Also, a first base resistance, RB₁, of the first base resistor 236, a first emitter resistance, RE₁, of the first emitter resistor 226, and a first clamp resistance, RD₁, of the first clamp resistor 240, satisfy the following condition: RB₁>RE₁>RD₁. Similarly, a second base resistance, RB₂, of the second base resistor 238, a second emitter resistance, RE₂, of the second emitter resistor 228, and a second clamp resistance, RD₂, of the second clamp resistor 244, satisfy the following condition: RB₂>RE₂>RD₂. The values of the first and second Schottky diodes 242, 246 are selected to be as small as possible, for example having forward voltages, V_{D}, below about 0.3V for forward currents, ID₁, ID₂, of about 10 mA each.

In a second state, the voltage drop across the first string of LEDs 202 is slightly less than the voltage drop across the second string of LEDs 204. Consequently, the first collector voltage, V₁, is greater than the second collector voltage, V₂, and a base voltage, V_{B}, of the first and second NPN transistors 220, 224 is equal to or greater than the first collector voltage, V₁, i.e. V_{B}≧V₁>V₂. The base voltage, V_{B}, therefore remains at about 0.7V higher than the second emitter voltage, VR₂, of the second NPN transistor 224. The second collector voltage, V₂, is clamped at the same voltage as in the first state by the second Schottky diode 246 and the second clamp resistor 244. The larger first collector voltage, V₁, results in the first collector current, IQ₁, flowing through the first PNP transistor 218, the first base resistor current, IR₁, flowing through the first base resistor 236, and the first diode current, ID₁, flowing through the first Schottky diode 242 and the first clamp resistor 240 to decrease so as to cause the first collector voltage, V₁, to increase so as to approach the base voltage, V_{B}, thereby causing the first current, IC₁, flowing through the first branch of the current mirror 212 substantially to match the second current, IC₂, flowing through the second branch of the current mirror 212 and therefore restore current flow stability. The increase in the first collector voltage, V₁, and the decrease in the first collector current, IQ₁, serve in this example as feedback signals, in particular negative feedback signals.

Similarly, when the voltage drop across the second string of LEDs 204 is slightly less than the voltage drop across the first string of LEDs 202, the second collector voltage, V₂, is greater than the first collector voltage, V₁, and the base voltage, V_{B}, of the first and second NPN transistors 220, 224 is equal to or greater than the second collector voltage, V₂, i.e. V_{B}≧V₂>V₁. Applying the same reasoning described above, but in respect of a converse situation, namely opposite sides of the current mirror 212 and the voltage controlled current source 214, the second collector voltage, V₂, increases and the second current, IQ₂, decreases, the driver circuit thereby causing the second current, IC₂, flowing through the second branch of the current mirror 212 substantially to match the first current, IC₁, flowing through the first branch of the current mirror 212 and therefore restore current flow stability. In this example, the increase in the second collector voltage, V₂, and the decrease in the second collector current, IQ₂, also serve in this example as feedback signals, in particular negative feedback signals.

In a third state, the voltage drop across the first string of LEDs 202 is much less, for example at least 0.7V, than the voltage drop across the second string of LEDs 204. In such a state, the first collector voltage, V₁, is greater than the second collector voltage, V₂. Additionally, the base voltage, V_{B}, of the first and second NPN transistors 220, 224 is greater than the second collector voltage, V₂, but not the first collector voltage, V₁, i.e. V₁>V_{B}>V₂. Employing the analysis employed in relation to the second state mentioned above, the base voltage, V_{B}, therefore remains at about 0.7V higher than the second emitter voltage, VR₂, of the second NPN transistor 224. However, the first emitter current, IQ₁ of the first PNP transistor 218 is about 0 mA if the first collector voltage, V₁, is about 0.6V (or less) below the voltage level of the supply rail, V_{CC}. Also, the direction of the first base resistor current, IR₁, is reversed. At the same time, the following expression holds true and a steady state is reached:

IR₁+IQ₂=IB₁+IB₂+ID₂+IR₂ (3)

The second collector voltage, V₂, the second base resistor current, IR₂, the second diode current, ID₂, and the second emitter current, IQ₂ are substantially maintained, whilst the first diode current, ID₁, the first base resistor current, IR₁, and the first emitter current, IQ₁ decrease to maintain circuit stability. The increase in the first collector voltage, V₁, and the decrease in the first emitter current, IQ₁ serve as feedback signals, in particular negative feedback signals, for controlling an operating voltage of the current mirror 212.

The same analysis can be employed in relation to the voltage drop across the second string of LEDs 204 being much less than the voltage drop across the first string of LEDs 202 such that V₂>V_{B}>V₁. Hence, the first collector voltage, V₁, the first base resistor current, IR₁, the first diode current, ID₁, and the first emitter current, IQ₁ are substantially maintained, whilst the second diode current, ID₂, the second base resistor current, IR₂, and the second emitter current, IQ₂ reduce to maintain circuit stability. The increase in the second collector voltage, V₂, and the decrease in the second emitter current, IQ₂ serve as feedback signals, in particular negative feedback signals, for controlling the operating voltage of the current mirror 212.

As mentioned above, it is also desirable to protect strings of LEDs from so-called “burn out” when one or more string of LEDs suffers an open circuit condition, thereby resulting in a possible over-current condition in one or more of the strings of LEDs, which can damage one or more LEDs in a given string of LEDs experiencing the over-current condition. In the following example, it is assumed that there is an open circuit in the first string of LEDs 202. Consequently, a large voltage drop exists across the first string of LEDs 202, resulting in the first collector voltage, V₁, being reduced to a very low voltage that is close to the first emitter voltage, VR₁. At the same time, the second NPN transistor 224 is maintained in the active region of operation, where the second collector voltage, V₂, satisfies the following condition: V₂>V_{B}=(VR₂+0.7V). The first NPN transistor 220 remains in the saturation region of operation, where the first collector voltage, V₁, is close to the first emitter voltage, VR₁, and the base voltage of the first and second NPN transistors 220, 224, V_{B}, satisfies the following condition: V_{B}=(VR+0.8V). As such, a resulting 0.1V voltage difference between the first and second emitter voltages, VR₁, VR₂, does not cause a significant current difference between the two branches of the driver circuit apparatus. In this regard, the current mirror 212 still maintains its function, such that for the voltage difference of 0.1V and an example resistance of the second resistor of 50Ω (0.1V/50Ω), the current difference is, for example, 2 mA, between the first current, IC₁, flowing through the first branch of the current mirror 212 and the second current, IC₂, flowing through the second branch of the current mirror 212. In this state, the current from the supply voltage, V_{CC} across the first emitter resistor 226 and the base-emitter junction of the first PNP transistor 218 combines with the first base resistor current, IR₁, and the first diode current, ID₁, to supply the first current, IC₁, flowing through the first branch of the current mirror 212.

In order to maintain correct operation in respect of the second string of LEDs 204, the second collector voltage, V₂, needs to climb sufficiently high to maintain the following current equation when the direction of second base resistor current, IR₂, is reversed, the second PNP transistor 222 is in an OFF state:

IR₂+IQ₁=IR₁+ID₁+IB₁+IB₂ (4)

The high value of the second collector voltage, V₂, serves to limit the voltage drop across the second string of LEDs 204, thereby limiting the current flowing through the second string of LEDs 204 to a level that is less than a maximum specification limit for the LED current that drives the second string of LEDs 204, and so protecting the second string of LEDs 204 and the driver circuit.

The skilled person will appreciate that the converse reasoning applies in relation to the occurrence of an open circuit condition in the second string of LEDs 204 as opposed to in the first string of LEDs 202.

It should be appreciated that whilst various aspects and embodiments of the present invention have heretofore been described, the scope of the present invention is not limited to the particular arrangements set out herein and instead extends to encompass all arrangements, and modifications and alterations thereto, which fall within the scope of the appended claims.

For example, although the above embodiments have been described in the context of a backlight for an LCD display, the skilled person should appreciate that the driver circuit described herein can be employed to drive LEDs for other applications, for example flashlights/torches, traffic signage, and advertising boards.

As another example, the above examples are described in relation to light emitting diodes. However, although this term includes the word “light” it should be understood that the examples are intended to be applicable to other devices requiring the current performance described herein. Consequently, references herein to “light” are made purely for convenience and to facilitate understanding without distracting from the salient aspects of the embodiments described herein, and the examples described herein should be understood to be applicable in relation to other wavelengths of electromagnetic radiation and not, for the avoidance of doubt, just wavelengths of electromagnetic radiation visible to the human eye.

Whilst embodiments described in the foregoing detailed description refer to GPS, it should be noted that the navigation device may utilise any kind of position sensing technology as an alternative to (or indeed in addition to) GPS. For example the navigation device may utilise using other global navigation satellite systems such as the European Galileo system. Equally, it is not limited to satellite based but could readily function using ground based beacons or any other kind of system that enables the device to determine its geographic location.

It will also be well understood by persons of ordinary skill in the art that whilst the preferred embodiment implements certain functionality by means of software, that functionality could equally be implemented solely in hardware (for example by means of one or more ASICs (application specific integrated circuit)) or indeed by a mix of hardware and software. As such, the scope of the present invention should not be interpreted as being limited only to being implemented in software.

Lastly, it should also be noted that whilst the accompanying claims set out particular combinations of features described herein, the scope of the present invention is not limited to the particular combinations hereafter claimed, but instead extends to encompass any combination of features or embodiments herein disclosed irrespective of whether or not that particular combination has been specifically enumerated in the accompanying claims at this time.

1. A driver circuit apparatus for light emitting diodes, the apparatus comprising:
a current mirror including:
a first branch for coupling to a first string of light emitting diodes; and
a second branch for coupling to a second string of light emitting diodes; and
a voltage controlled current source coupled to the current mirror including:
a first switching device having a control terminal for coupling to the first string of light emitting diodes; and
a second switching device having a control terminal for coupling to the second string of light emitting diodes.

2. An apparatus as claimed in claim 1, wherein the voltage controller current source includes:
a first branch coupled to the first branch of the current mirror; and
a second branch coupled to the second branch of the current mirror.

3. An apparatus as claimed in claim 1, wherein the voltage controlled current source is arranged to generate a feedback signal for controlling an operating voltage of the current mirror.

4. An apparatus as claimed in claim 1, wherein the current mirror comprises a first switching device having a control terminal and a second switching device having a control terminal, the control terminal of the first switching device being coupled to the control terminal of the second switching device.

5. An apparatus as claimed in claim 4, wherein the first switching device of the current mirror comprises a first conduction terminal for coupling to the first string of light emitting diodes, and the second switching device of the current mirror comprises a first conduction terminal for coupling to the second string of light emitting diodes.

6. An apparatus as claimed in claim 4, wherein the first switching device of the current mirror comprises a second conduction terminal coupled to a first current source, and the second switching device of the current mirror comprises a second conduction terminal coupled to a second current source.

7. An apparatus as claimed in claim 4, wherein the first switching device of the current mirror is a first transistor device and the second switching device of the current mirror is a second transistor device.

8. (canceled)

9. An apparatus as claimed in claim 5, wherein the control terminal of the first switching device of the voltage controlled current source is coupled to the first conduction terminal of the first switching device of the current mirror, and the control terminal of the second switching device of the voltage controlled current source is coupled to the first conduction terminal of the second switching device of the current mirror.

10. An apparatus as claimed in claim 1, wherein the control terminal of the first switching device of the voltage controlled current source is coupled to a first voltage clamp.

11. An apparatus as claimed in claim 1, wherein the control terminal of the second switching device of the voltage controlled current source is coupled to a second voltage clamp.

12. An apparatus as claimed in claim 1, wherein a first conduction terminal of the first switching device of the voltage controlled current source is coupled to a first current source and a first conduction terminal of the second switching device of the voltage controlled current source is coupled a second current source.

13. An apparatus as claimed in claim 4, wherein a second conduction terminal of the first switching device of the voltage controlled current source is coupled to the control terminal of the first switching device of the current mirror, and a second conduction terminal of the second switching device of the voltage controlled current source is coupled to the control terminal of the second switching device of the current mirror.

14. An apparatus as claimed in claim 1, further comprising a resistance coupled between the control terminal and the second conduction terminal of the first switching device of the voltage controlled current source, and a resistance coupled between the control terminal and the second conduction terminal of the second switching device of the voltage controlled current source.

15. An apparatus as claimed in claim 1, wherein the first switching device of the voltage controlled current source is a third transistor device and the fourth switching device of the voltage controlled current source is a fourth transistor device.

16. An apparatus as claimed in claim 2, wherein the first and second branches of the current mirror are substantially symmetric and the first and second branches of the voltage controlled current source are substantially symmetric.

17. A light source apparatus comprising:
a driver circuit apparatus, comprising:
a current mirror including:
a first branch for coupling to a first string of light emitting diodes; and
a second branch for coupling to a second string of light emitting diodes; and
a voltage controlled current source coupled to the current mirror including:
a first switching device having a control terminal for coupling to the first string of light emitting diodes; and
a second switching device having a control terminal for coupling to the second string of light emitting diodes;
a first string of light emitting diodes; and
a second string of light emitting diodes;
wherein the first string of light emitting diodes is coupled to the first branch of the current mirror, and the second string of light emitting diodes is coupled to the second branch of the current mirror.

18. A navigation device comprising the driver circuit apparatus as claimed in claim 1.

19. (canceled)
